(19) United States
(12) Patent Application Publication
(10) Pub. No.: US 2023/0305134 A1
(43) Pub. Date: Sep. 28, 2023

(54) SENSOR DEVICE, SYSTEM, AND SOUND DETECTION METHOD

(71) Applicant: Asahi Kasei Microdevices Corporation, Tokyo (JP)

(72) Inventors: Seiji TAKEUCHI, Tokyo (JP); Osamu IKEUCHI, Tokyo (JP)

(21) Appl. No.: 18/187,680

(22) Filed: Mar. 22, 2023

(30) Foreign Application Priority Data
Mar. 23, 2022 (JP) 2022-047524

(51) Int. Cl. G01S 13/56; G01S 7/35; G01S 13/536; G01S 13/86; G01S 7/41; G10L 25/21; G10L 25/51

(52) U.S. Cl. CPC G01S 13/56; G01S 7/356; G01S 13/536; G01S 13/86; G01S 7/415; G10L 25/21; G10L 25/51

(57) ABSTRACT

Provided are a sensor device for sensing an object using an FMCW radar and including: a signal processing unit for acquiring a reception signal based on a reception wave of the FMCW radar and outputting a processing signal obtained by sensing the object; a sound detection unit for detecting a sound-related signal related to a sound from the object on a basis of the processing signal; and a mode control unit for switching an operation mode of the sensor device between an object detection mode for detecting the object and a sound detection mode for detecting a sound from the object on a basis of a detection result of the sound detection unit, and a system including an FMCW radar including a transmission/reception unit for transmitting and receiving an FMCW radar signal and the sensor device according to a first aspect of the present invention. [Selected Drawing] FIG. 1A

The contents of the following Japanese patent application(s) are incorporated herein by reference:
NO. 2022-047524 filed in JP on Mar. 23, 2022

### BACKGROUND

### 1. Technical Field

The present invention relates to a sensor device, a system, and a sound detection method.

### 2. Related Art

Conventionally, there is known a microphone device that determines whether a speaker is speaking by using a Doppler radar, and sets a switch for sound output to ON when a signal of a predetermined level is supplied from an utterance determination unit (see, for example, Patent Document 1).
Patent Document 1: Japanese Patent Application Publication No. 2006-047607

### BRIEF DESCRIPTION OF THE DRAWINGS

FIG. 1A illustrates an outline of a configuration of a system 200.

FIG. 1B illustrates an example of an FMCW radar transmitted by a transmission unit 12.

FIG. 1C is a diagram for explaining a distance R, a velocity V, and an angle θ of an object 300.

FIG. 1D is a diagram for explaining the distance R, the velocity V, the angle θ, and an angle ϕ of the object 300.

FIG. 2A illustrates an outline of information processing in a first mode.

FIG. 2B illustrates an outline of the information processing in a second mode.

FIG. 2C illustrates an outline of the information processing in a third mode.

FIG. 3A illustrates an outline of configurations of an input unit 20 and a signal processing unit 30.

FIG. 3B illustrates an outline of configurations of the signal processing unit 30 and a data output unit 40.

FIG. 4 illustrates an outline of a configuration of a sound detection unit 50.

FIG. 5A illustrates an update rate requested in the first mode.

FIG. 5B illustrates an update rate requested in the second mode.

FIG. 5C illustrates an update rate requested in the third mode.

FIG. 5D illustrates a chirp setting requested in an object detection mode.

FIG. 5E illustrates a chirp setting requested in a sound detection mode.

FIG. 6A illustrates an example of an operation of a sensor device 100 in the object detection mode.

FIG. 6B illustrates an example of the operation of the sensor device 100 in the sound detection mode.

FIG. 6C illustrates an example of the operation of the sensor device 100 of the present example.

FIG. 6D illustrates an example of the operation of the sensor device 100 of the present example.

### DESCRIPTION OF EXEMPLARY EMBODIMENTS

Hereinafter, embodiments of the present invention will be described. However, the following embodiments are not for limiting the invention according to the claims. In addition, some combinations of features described in the embodiments may not be essential for the solving means of the invention.

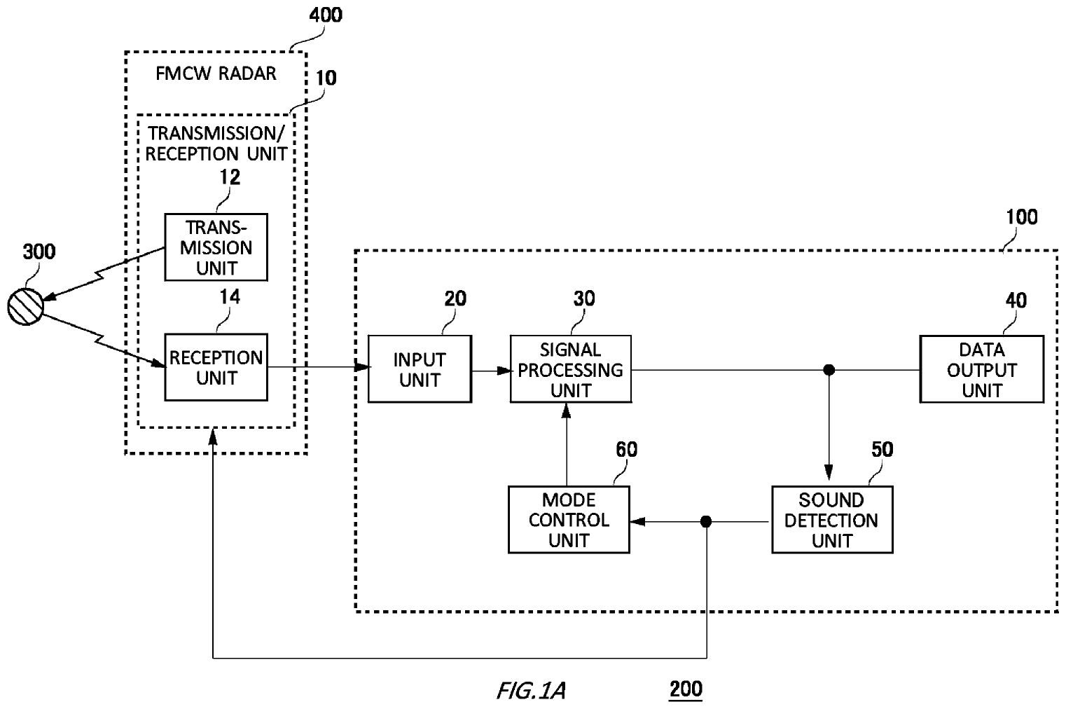

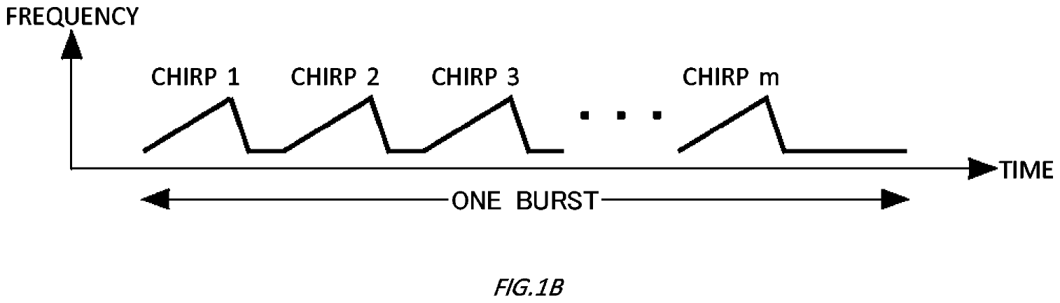

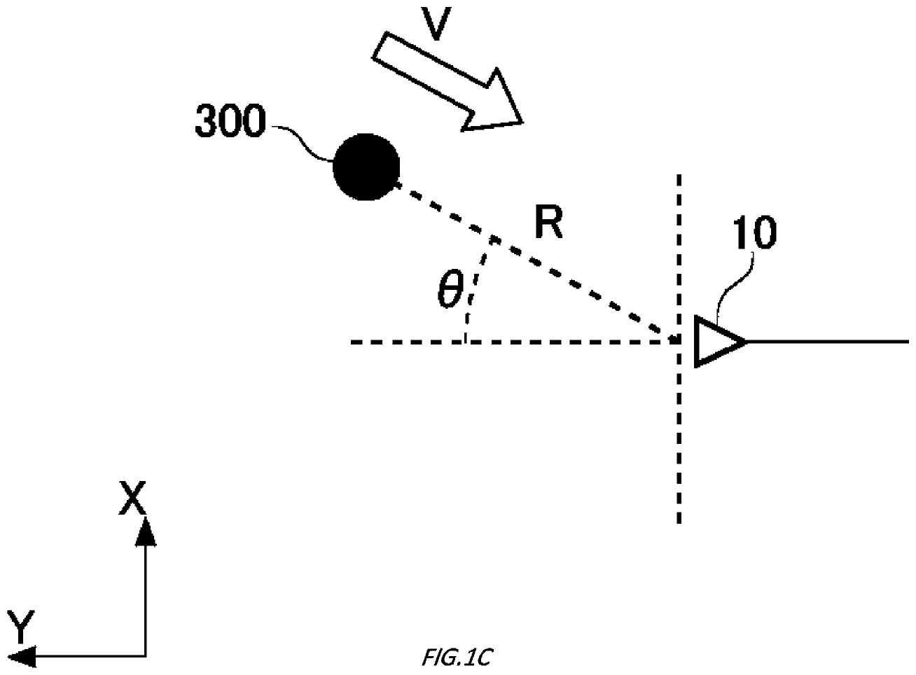

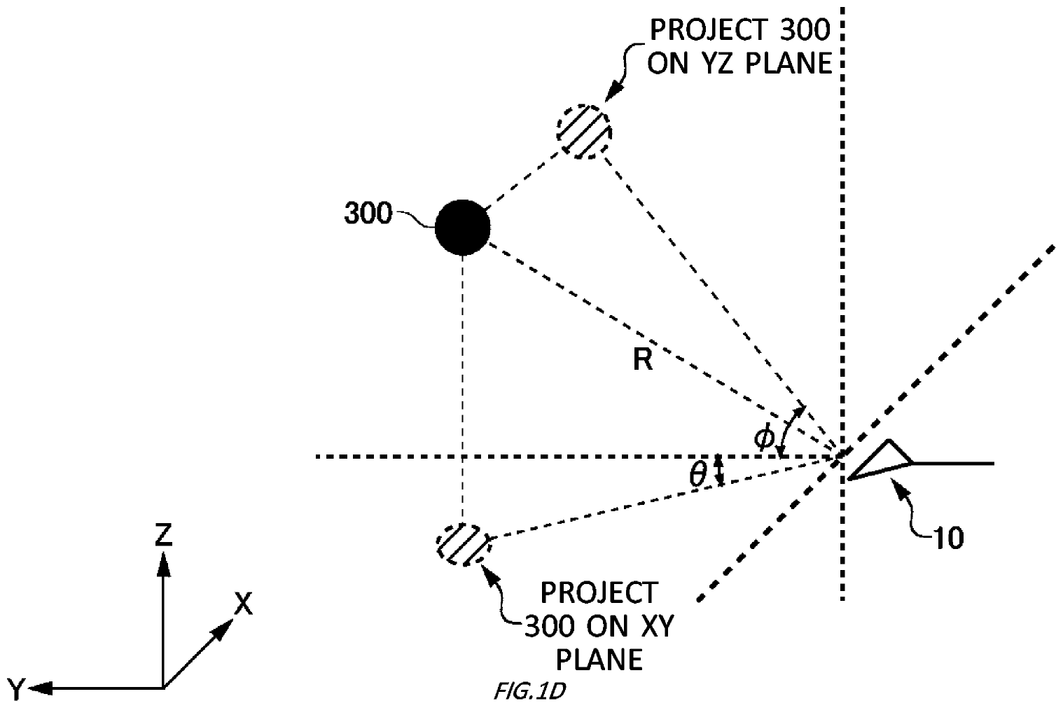

FIG. 1A illustrates an outline of a configuration of a system 200. The system 200 includes an FMCW radar 400 having a transmission/reception unit 10 and a sensor device 100. The system 200 senses an object 300. The transmission/reception unit 10 includes a transmission unit 12 and a reception unit 14. The sensor device 100 includes an input unit 20, a signal processing unit 30, a data output unit 40, a sound detection unit 50, and a mode control unit 60.

The transmission unit 12 transmits a frequency modulated continuous wave radar (FMCW radar) signal as a transmission wave to the object 300. The FMCW radar signal is a continuous wave radar in which a frequency is modulated. For example, an FMCW radar signal has a burst wave including a plurality of chirps. In each chirp, the frequency is swept in time. The sensor device 100 of the present example calculates a distance R by phase, thereby using the FMCW radar signal for biological sensing for detecting micro-vibration in units of several mm.

The reception unit 14 receives a reflected wave of the FMCW radar signal reflected by the object 300 and outputs an IF signal. The IF signal is a signal down-converted to an intermediate frequency (IF) frequency proportional to a time of flight (TOF) of the reflected wave. The TOF is a time until a transmitted transmission wave is received as a reflected wave. The TOF increases as the distance R between the sensor device 100 and the object 300 increases. The sensor device 100 calculates the distance R and a velocity V of the object 300 by performing AD conversion on the IF signal and performing signal processing. The sensor device 100 may include a plurality of reception units 14. The sensor device 100 can acquire information related to an angle θ of the position of the object 300 by including the plurality of reception units 14.

The IF signal obtained by down-converting the reflected wave of the object 300 received by the reception unit 14 is input to the input unit 20. The input unit 20 converts the input analog IF signal into a digital signal. For example, the transmission/reception unit 10 and the input unit 20 are integrated circuits such as RFIC.

The signal processing unit 30 senses the object 300 on the basis of the digital reception signal output from the input unit 20. For example, the signal processing unit 30 is a digital signal processor (DSP). In the present specification, sensing of the object 300 refers to acquiring body motion data, micro-vibration data, and sound data of the object 300. In the present specification, the body motion data is data including information such as the distance R, the velocity V, and the angle θ of the object 300. The micro-vibration data is data obtained by analyzing micro-vibration information of the object 300. The sound data is data obtained by analyzing the sound information of the object 300. Details of each data will be described later.

The signal processing unit 30 acquires position information and form information of the object 300 on the basis of the digital reception signal output from the input unit 20. Herein, the position information may include information regarding the distance R, the velocity V, and the angle θ of the object 300, and the form information may include information regarding the shape, the posture, and the number of objects 300. In addition, the signal processing unit 30 may output, as the body motion data, the position information and the form information together to the outside.

The signal processing unit 30 senses the object 300 on the basis of the micro-vibration information or the sound information of the object 300. In the present specification, the micro-vibration information indicates vibration information of the object 300 in units of several millimeters. As an example, the micro-vibration information includes biological information such as respiration or heartbeat when the object 300 is a living body. In the present specification, the sound information indicates vibration information associated with the object 300 uttering a sound. As an example, the sound information includes the micro-vibration information at the utterance position of the object 300.

In an example, the sensor device 100 obtains, as the micro-vibration data, vibration with a resolution that maximizes the wavelength of the FMCW radar signal. For example, the resolution is 100 to 1000 times the resolution of one wavelength in a millimeter wave band (frequency band of about 30 to 300 GHz) often used in the FMCW radar 400.

The data output unit 40 receives the processing signal output from the signal processing unit 30 and outputs the body motion data, the micro-vibration data, and the sound data. The processing signal may include at least one piece of information among information included in the body motion data, the micro-vibration data, and the sound data regarding the object 300 sensed by the signal processing unit 30. The data output unit 40 may output the data included in the input processing signal by a method to be described later.

The sound detection unit 50 detects a sound-related signal of the object 300. The sound-related signal may include sound information uttered by the object 300 or information related to a preliminary motion for uttering a sound. The information related to the preliminary motion for uttering a sound may be at least one of the position information, the form information, or the micro-vibration information. The sound-related signal may include at least one piece of information among the information included in the body motion data, the micro-vibration data, or the sound data regarding the object 300 sensed by the signal processing unit 30. The sound detection unit 50 may detect the utterance of object 300 on the basis of one or more pieces of information included in the sound-related signal. The sound detection unit 50 outputs a switching signal for switching the operation modes of the sensor device 100 and the transmission/reception unit 10 to the mode control unit 60 on the basis of the detection result.

The mode control unit 60 acquires the switching signal output from the sound detection unit 50. The mode control unit 60 may switch the operation modes of the sensor device 100 and the transmission/reception unit 10 on the basis of the switching signal. In addition, the mode control unit 60 may switch the operation frequency of the system 200 on the basis of the switching signal.

The operation modes of the sensor device 100 and the transmission/reception unit 10 may include an object detection mode for acquiring the position information, the form information, and the micro-vibration information of the object 300, and a sound detection mode for acquiring the sound information. The object detection mode may include a first mode for acquiring the position information and the form information of the object 300 and a second mode for acquiring the micro-vibration information. The sound detection mode may include a third mode for acquiring the sound information.

The sensor device 100 senses the object 300 by transmitting an FMCW radar signal to the object 300. By appropriately processing a reception signal based on the modulated frequency of the FMCW radar signal, the sensor device 100 can detect the object 300 with no change in distance to the object 300 even when a relative velocity between the sensor device 100 and the object 300 is 0.

The signal processing unit 30 may sense a plurality of objects 300 by identifying a plurality of peaks of the power conversion spectrum of the reception signal. The sensor device 100 can acquire the distances R, the velocities V, and the angles θ of the plurality of objects 300 by using the FMCW radar signal.

Since the sensor device 100 uses the FMCW radar signal, in a system that detects the distances R, the velocities V, and the angles θ of one or more objects 300 existing in a wide space, scanning may be performed with a wide-angle beam, and it is not necessary to perform scanning with a narrow beam. In addition, the sensor device 100 can realize biological sensing only by adding simple signal processing such as phase conversion simultaneously with the detection of the object 300 by the FMCW radar signal.

Since the sensor device 100 does not require an external sound input device such as a microphone, it is possible to realize sound detection in a noisy environment or individual detection in a case where a plurality of sounds are uttered simultaneously.

FIG. 1B illustrates an example of the FMCW radar signal transmitted by the transmission unit 12. The FMCW radar signal includes m chirps in one burst. m is an integer of 2 or more. The sensor device 100 modulates the frequency of the chirp and analyzes a difference between the transmission wave and the reception wave to calculate the distance R, the velocity V, and the angle θ of the object 300. The sensor device 100 may appropriately adjust the modulation width and the cycle of the frequency of the chirp according to the position or the state of the object 300. The FMCW radar signal of the present example includes m chirps of the same waveform, but may include chirps of different waveforms.

The FMCW radar 400 is a radar that detects a distance to a target and a relative velocity by using a time difference by which an echo from the object 300 returns. The FMCW radar 400 of the present example adopts a first chirp FMCW system with emphasis on short distance detection at a wider angle. For example, the FMCW radar 400 linearly raises or lowers the frequency at a cycle of about several microseconds to several hundred microseconds, and uses only one of up and down for detection. However, in the FMCW system, both up and down may be used for detection.

The FMCW radar 400 can simultaneously detect angle information by arranging a plurality of channels. For example, the FMCW radar 400 realizes long distance detection in a 76G band (76 to 77 GHz), and realizes middle distance detection and short distance detection in a 79G band (77 to 81 GHz). Note that the FMCW radar 400 may have a system in which the frequency is linearly raised or lowered in a cycle of about several milliseconds to several hundred milliseconds.

On the other hand, a Doppler radar is a radar that detects the distance to the target and the relative velocity by using the Doppler shift caused by the relative velocity of the target. For example, the Doppler radar is represented by a two-frequency CW system. The Doppler radar cannot detect the target without the Doppler shift. In addition, since the Doppler radar recognizes a plurality of targets as one target at an intermediate distance, the plurality of targets cannot be detected.

FIG. 1C is a diagram for explaining the distance R, the velocity V, and the angle θ of the object 300. This drawing illustrates a case where the transmission wave of the FMCW radar signal is transmitted from the transmission/reception unit 10, and the reflected wave from the object 300 is received by the transmission/reception unit 10. In the present example, for the sake of simplicity, the transmission unit 12 and the reception unit 14 are considered as the same position.

The object 300 fluctuates at the velocity V at a position at the distance R from the transmission/reception unit 10. The velocity V is a relative velocity between the transmission/reception unit 10 and the object 300. The angle θ is an angle of the object 300 as viewed from the transmission/reception unit 10. Specifically, when a direction in which the reception units 14 are arranged is an X axis direction, and a direction perpendicular to an X axis on which the FMCW radar signal is emitted is a Y axis, the angle θ is an angle formed on an XY plane by the Y axis and the position of the object 300.

FIG. 1D is a diagram for explaining the distance R, the velocity V, the angle θ, and an angle ϕ of the object 300. Even as a so-called 3D radar that detects a new axis (Z axis) perpendicular to the XY plane, the sensor device 100 can sense the object 300 on a similar principle. In this case, the sensor device 100 acquires three-dimensional information by using the angle ϕ obtained when the object 300 is projected on the YZ plane in addition to the angle θ obtained when the object is projected on the XY plane.

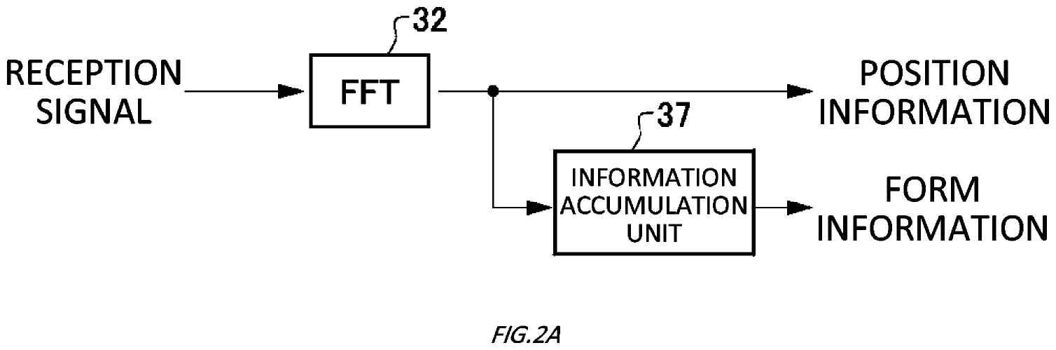

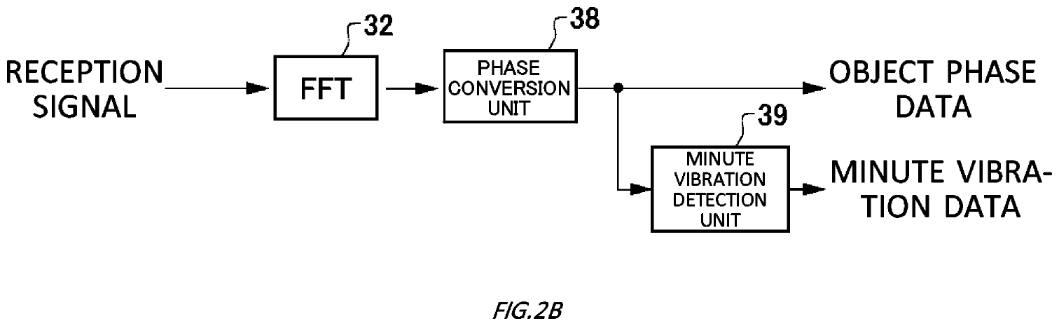

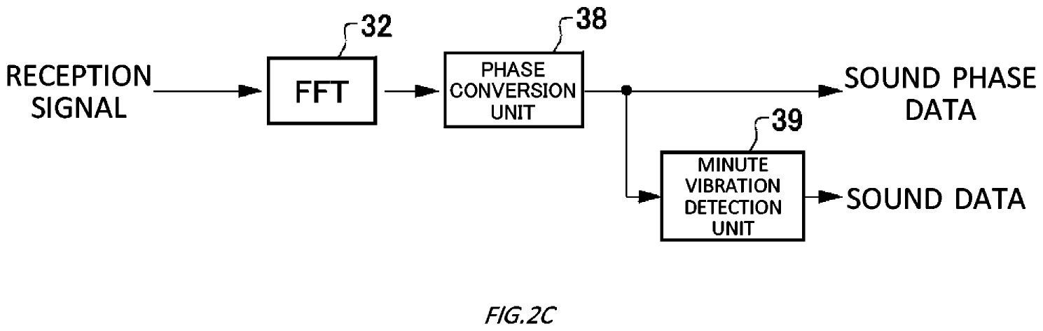

FIG. 2A is a diagram illustrating a flow of information processing in the first mode. In the first mode, the digital reception signal output from the input unit 20 is input to an FFT conversion unit 32 described later. The FFT conversion unit 32 performs frequency analysis on the input digital reception signal. As a result, the position information of the detected object 300 can be obtained.

An information accumulation unit 37 performs clustering processing and tracking processing on the position information of the object 300. In the present specification, the clustering processing indicates that the shape and the number of objects 300 are identified by integrating the position information with respect to a plurality of coordinates. The tracking processing indicates that a change in position information of the plurality of coordinates is tracked to identify a temporal change in shape and number. As a result, the form information of the detected object 300 can be obtained. The information accumulation unit 37 will be described later.

FIG. 2B is a diagram illustrating a flow of the information processing in the second mode. Also in the second mode, similarly to the first mode, the FFT conversion unit 32 performs frequency analysis on the input digital reception signal. In the second mode, the position information regarding the object 300 obtained in this way is output to a phase conversion unit 38 described later.

The phase conversion unit 38 specifies coordinates for detecting micro-vibration in the input information regarding the object 300. Subsequently, the phase of the specified coordinates is extracted to acquire the object phase data. The phase conversion unit 38 may output the extracted object phase data to a micro-vibration identification unit 39.

The micro-vibration identification unit 39 performs frequency analysis on the object phase data input by the phase conversion unit 38. As a result, the micro-vibration data of the detected object 300 can be obtained.

FIG. 2C is a diagram illustrating a flow of the information processing in the third mode. Also in the third mode, similarly to the second mode, the position information of the object 300 is input to the phase conversion unit 38.

The phase conversion unit 38 specifies coordinates, at which the utterance vibration appears strongly with the utterance of the object 300, in the input position information. Subsequently, the phase of the specified coordinates is extracted to acquire the sound phase data. The phase conversion unit 38 may output the extracted sound phase data to the micro-vibration identification unit 39.

The micro-vibration identification unit 39 performs frequency analysis on the sound phase data input by the phase conversion unit 38. As a result, the sound data of the detected object 300 can be obtained.

As illustrated in FIGS. 2A to 2C, a signal processing function necessary for sensing the object 300 in each operation mode includes frequency analysis such as FFT conversion. In the present example, the FFT conversion unit 32 and the micro-vibration identification unit 39 perform frequency analysis. Although the FFT conversion unit 32 and the micro-vibration identification unit 39 have been described as different configurations, there is no substantial difference in required performance, and thus a single frequency analysis unit may be used.

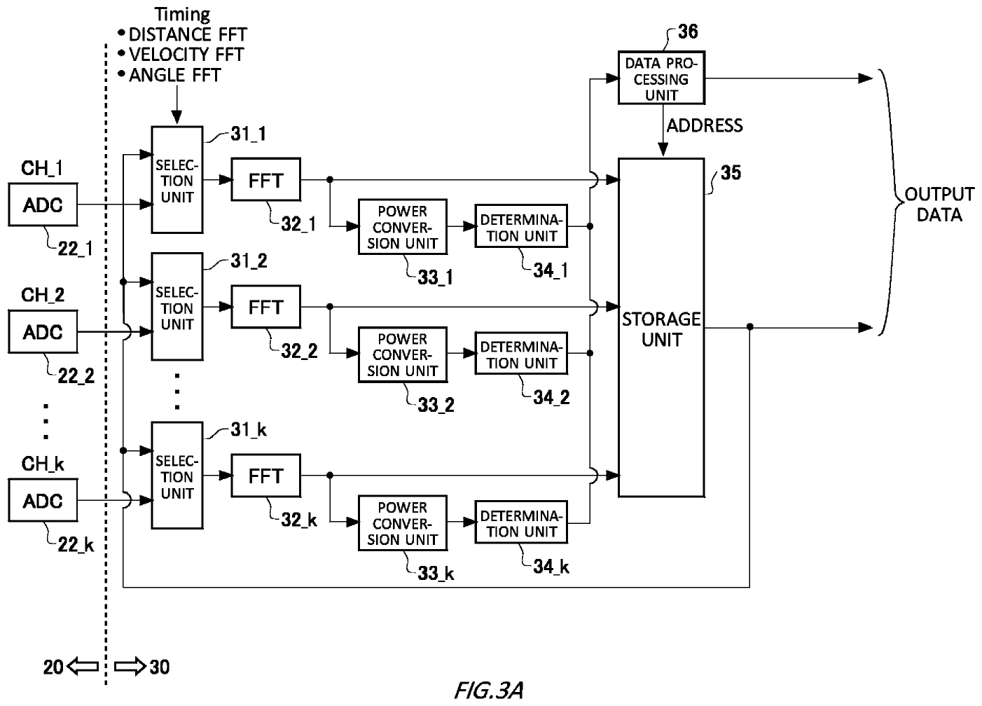

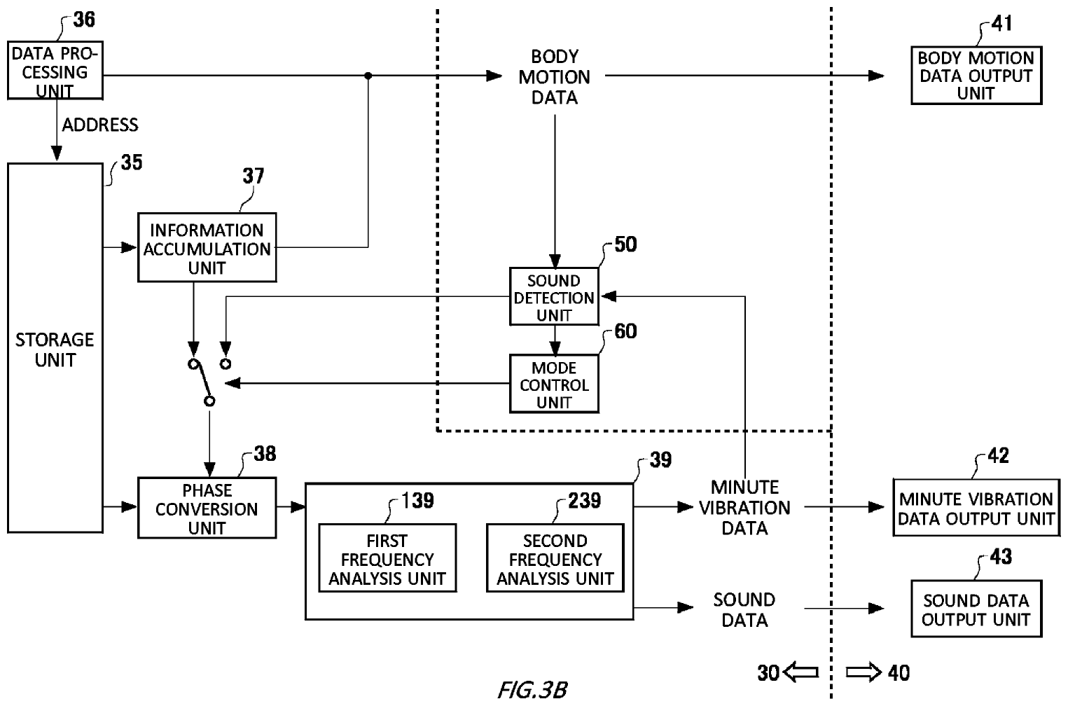

FIG. 3A illustrates an example of a configuration of the sensor device 100. The input unit 20 includes an AD conversion unit 22. The signal processing unit 30 includes a selection unit 31, an FFT conversion unit 32, a power conversion unit 33, a determination unit 34, a storage unit 35, and a data processing unit 36.

The AD conversion unit 22 converts the IF signal output from the reception unit 14 into a digital signal. The AD conversion unit 22 may be provided for every k channels. The AD conversion unit 22 transmits the converted digital reception signal to the signal processing unit 30. The AD conversion unit 22 performs AD conversion a sampling number n of times in a state where the waveform of the chirp is up or down.

The digital reception signal converted by the AD conversion unit 22 is input to the selection unit 31. The selection unit 31 selects a digital reception signal at a timing corresponding to any one of the distance FFT, the velocity FFT, and the angle FFT. The selection unit 31 outputs the selected digital reception signal to the FFT conversion unit 32. The k selection units 31 are provided corresponding to k channels. For example, the selection unit 31 selects a reception signal at the time of distance FFT, and selects data stored in the storage unit 35 at the time of velocity FFT and angle FFT.

The FFT conversion unit 32 performs FFT conversion on the digital reception signal output from the AD conversion unit 22 or the signal stored in the storage unit 35. The k FFT conversion units 32 are provided corresponding to the k channels. The FFT conversion unit 32 executes any one of the distance FFT, the velocity FFT, and the angle FFT according to the data selected by the selection unit 31.

The power conversion unit 33 calculates a power spectrum on the basis of the signal converted by the FFT conversion unit 32. By calculating the power spectrum, the distance R, the velocity V, and the angle θ of the object 300 can be identified. The k power conversion units 33 are provided corresponding to the k channels.

The determination unit 34 determines the peak position of the power spectrum.

Accordingly, the determination unit 34 detects the presence of the object 300. In an example, the determination unit 34 determines BIN having a higher spectrum level than the surroundings. For example, the determination unit 34 executes constant false alarm ratio (CFAR) processing. By executing the CFAR processing, the determination unit 34 can separate unnecessary signals such as clutter and execute more accurate peak BIN identification. The k determination units 34 are provided corresponding to the k channels.

The storage unit 35 stores the FFT conversion signal output from the FFT conversion unit 32. The storage unit 35 outputs the stored data to the selection unit 31. In addition, the storage unit 35 may output the stored data to the outside. The storage unit 35 stores each of a distance data string having a BIN number of n/2, a velocity data string having a BIN number of m, and an angle data string having a BIN number of k. n is the number of ADC samplings per chirp, m is the number of chirps per burst, and k is the number of channels.

The data processing unit 36 designates the address of the storage unit 35 according to the output result of the determination unit 34. The address indicated by the data processing unit 36 means the peak BIN position of the power spectrum of each of the distance, the velocity, and the angle, that is, may be output, as the detection result of the distance, the velocity, and the angle of the object 300, to the outside.

FIG. 3B illustrates an example of a configuration of the sensor device 100. The present drawing illustrates a configuration of a subsequent stage of the sensor device 100 illustrated in FIG. 3A. The signal processing unit 30 includes the information accumulation unit 37, the phase conversion unit 38, and the micro-vibration identification unit 39. The data output unit 40 includes a body motion data output unit 41, a micro-vibration data output unit 42, and a sound data output unit 43.

The data processing unit 36 may output the position information of the object 300 to the body motion data output unit 41. Herein, the position information may be output as the body motion data together with the form information.

The storage unit 35 may output the stored position information to the information accumulation unit 37 and the phase conversion unit 38.

The information accumulation unit 37 may process the data input from the storage unit 35 and output the form information of the object 300 to the body motion data output unit 41. In addition, the information accumulation unit 37 may output body motion information to the phase conversion unit 38.

The phase conversion unit 38 specifies coordinates for identifying the micro-vibration of the object 300 by using the position information of the object 300 input from the storage unit 35 and the form information of the object 300 input from the information accumulation unit 37, and extracts a phase of the specified coordinates to acquire the object phase data of the object 300. The phase conversion unit 38 may output the extracted object phase data to a micro-vibration identification unit 39.

The micro-vibration identification unit 39 may include a first frequency analysis unit 139 for acquiring the micro-vibration data of the object 300. The micro-vibration identification unit 39 acquires the micro-vibration data of the object 300 by performing frequency analysis on the object phase data input from the phase conversion unit 38. The micro-vibration identification unit 39 may output the acquired micro-vibration data of the object 300 to the micro-vibration data output unit 42.

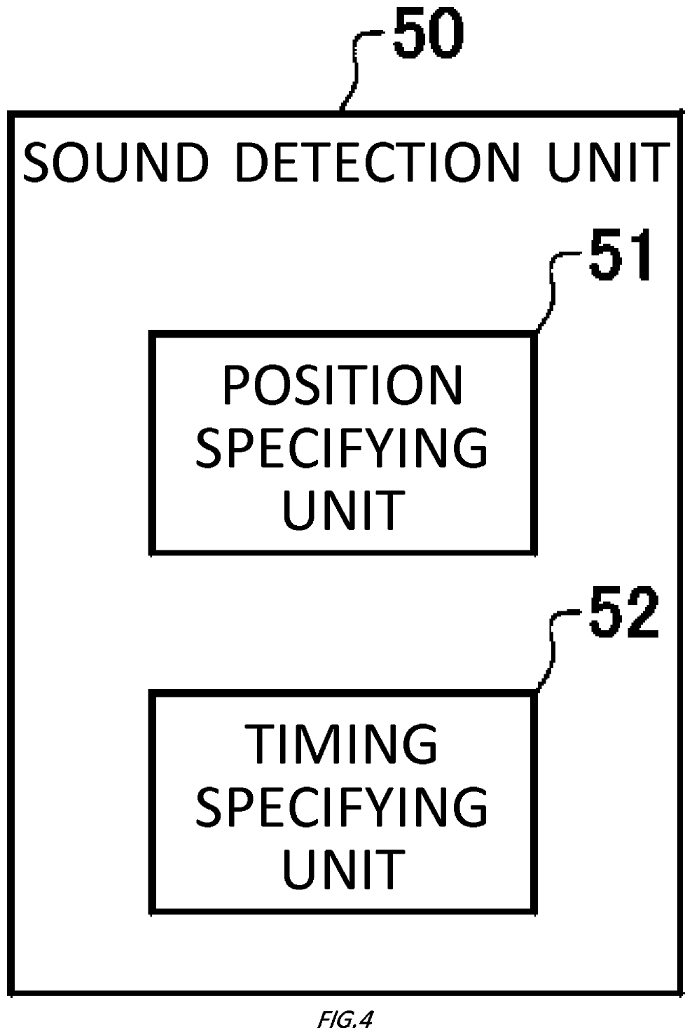

When determining that the object 300 is uttering a sound, performing a preliminary motion for uttering a sound, or not uttering a sound, the sound detection unit 50 may output, to the mode control unit 60, a switching signal for switching a mode. A method in which the sound detection unit 50 determines that the object 300 is uttering a sound, performing a preliminary motion for uttering a sound, or not uttering a sound will be described with reference to FIG. 4.

FIG. 4 illustrates an example of a configuration of the sound detection unit 50. The sound detection unit 50 includes a position specifying unit 51 and a timing specifying unit 52.

On the basis of the body motion data and the micro-vibration data, the position specifying unit 51 specifies the utterance position of the sound among the position coordinates of the object 300. On the basis of the form information of the target object 300, the position specifying unit 51 may specify coordinates of a position where micro-vibration appears strongly at the time of utterance of the object 300. For example, when the object 300 is a living body, the coordinates of the lip or neck of the object 300 may be specified on the basis of the form information.

In addition, the position specifying unit 51 may analyze the object phase data of the sensed object 300 and specify coordinates at which the micro-vibration data is obtained most strongly. The position specifying unit 51 may output information regarding the specified coordinates to the phase conversion unit 38.

On the basis of the body motion data and the micro-vibration data, the timing specifying unit 52 specifies a timing at which the object 300 utters a sound and a timing at which the object does not utter a sound. As an example, a case where the object 300 is a living body will be specifically described.

The timing specifying unit 52 may specify the timing of the utterance on the basis of body motion data such as taking in more breath as the object 300 utters. In addition, on the basis of micro-vibration data regarding a change in the number of breaths of the object 300, the timing specifying unit 52 may determine whether the object 300 is uttering a sound. In addition, the timing specifying unit 52 may determine whether the object 300 is performing a preliminary motion of uttering a sound.

Returning to FIG. 3B, the mode control unit 60 switches the operation modes of the sensor device 100 and the transmission/reception unit 10 on the basis of the switching signal from the sound detection unit 50. Specifically, when the sound detection unit 50 determines that the object 300 is uttering a sound or performing a preliminary motion for uttering a sound, the mode control unit 60 switches the operation modes of the sensor device 100 and the transmission/reception unit 10 from the object detection mode to the sound detection mode.

When the sensor device 100 and the transmission/reception unit 10 are operating in the sound detection mode, the information output from the sound detection unit 50 and regarding coordinates at which micro-vibration appears strongly is input to the phase conversion unit 38. At the timing when the micro-vibration appears strongly, the phase conversion unit 38 extracts the phase of the coordinates at which the micro-vibration appears strongly. The phase conversion unit 38 may output the extracted sound phase data to the micro-vibration identification unit 39.

The micro-vibration identification unit 39 may include a second frequency analysis unit 239 for acquiring sound data emitted by the object 300. The micro-vibration identification unit 39 acquires the sound data emitted by the object 300 by performing frequency analysis on the sound phase data of the object 300 input from the phase conversion unit 38. The micro-vibration identification unit 39 may output the acquired sound data emitted by the object 300 to the sound data output unit 43 and the timing specifying unit 52.

When the sensor device 100 and the transmission/reception unit 10 are operating in the sound detection mode, the timing specifying unit 52 may determine that the object 300 does not utter a sound since no sound data is output for a predetermined period. In addition, when the sensor device 100 and the transmission/reception unit 10 are operating in the sound detection mode, in a case where the sound detection unit 50 determines that the object 300 does not utter a sound, the mode control unit 60 switches the operation modes of the sensor device 100 and the transmission/reception unit 10 from the sound detection mode to the object detection mode.

Herein, the description has been given such that the micro-vibration identification unit 39 acquires micro-vibration data by using the first frequency analysis unit 139 and acquires sound data by using the second frequency analysis unit 239, but the present example is not limited thereto. That is, since there is no substantial difference in performance required between the first frequency analysis unit 139 and the second frequency analysis unit 239, the micro-vibration identification unit 39 may be configured to function as a single frequency analysis unit.

As an example, in a case where the micro-vibration identification unit 39 functions as a single frequency analysis unit, the micro-vibration identification unit 39 may function as the first frequency analysis unit 139 when the sensor device 100 operates in the object detection mode. Similarly, when the sensor device 100 and the transmission/reception unit 10 operate in the sound detection mode, the micro-vibration identification unit 39 may function as the second frequency analysis unit 239.

The body motion data output unit 41 outputs the body motion data processed by the signal processing unit 30. The body motion data output unit 41 may output the position information and the form information of the object 300 detected by the sensor device 100. The body motion data output unit 41 may output information in a form of displaying a point group in a space, may output information in a form of displaying a numerical value, may output information in a form of displaying a sentence, or may output information in a form of reading out a sound. The body motion data output unit 41 may be a device, such as a monitor, capable of displaying a video or may be a device, such as a speaker, capable of outputting a sound.

The micro-vibration data output unit 42 outputs the micro-vibration data processed by the signal processing unit 30. The micro-vibration data output unit 42 may output the micro-vibration information of the object 300 detected by the sensor device 100. The micro-vibration data output unit 42 may output information in a form of displaying a point group in a space, may output information in a form of displaying a numerical value, may output information in a form of displaying a sentence, or may output information in a form of reading out a sound. The micro-vibration data output unit 42 may be a device, such as a monitor, capable of displaying a video or may be a device, such as a speaker, capable of outputting a sound.

The sound data output unit 43 outputs the sound data processed by the signal processing unit 30. The sound data output unit 43 may output the sound information of the object 300 detected by the sensor device 100. The output of the information may be performed in a form of displaying a point group in a space, may be performed in a form of displaying a numerical value, may be performed in a form of displaying a sentence, or may be performed in a form of reading out a sound. The sound data output unit 43 may be a device, such as a monitor, capable of displaying a video or may be a device, such as a speaker, capable of outputting a sound.

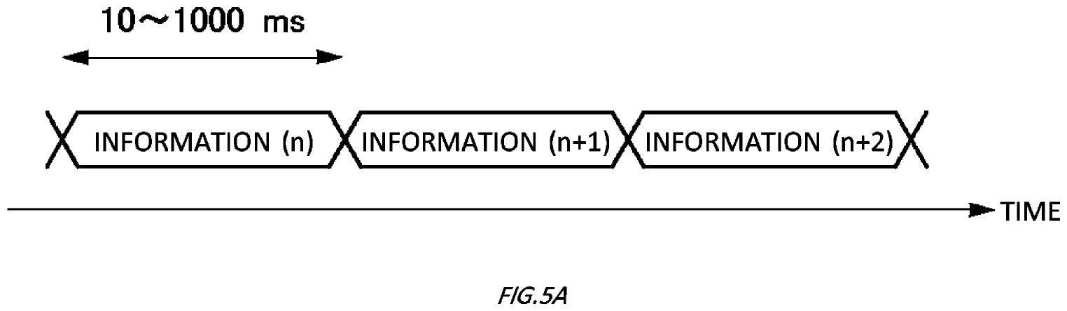

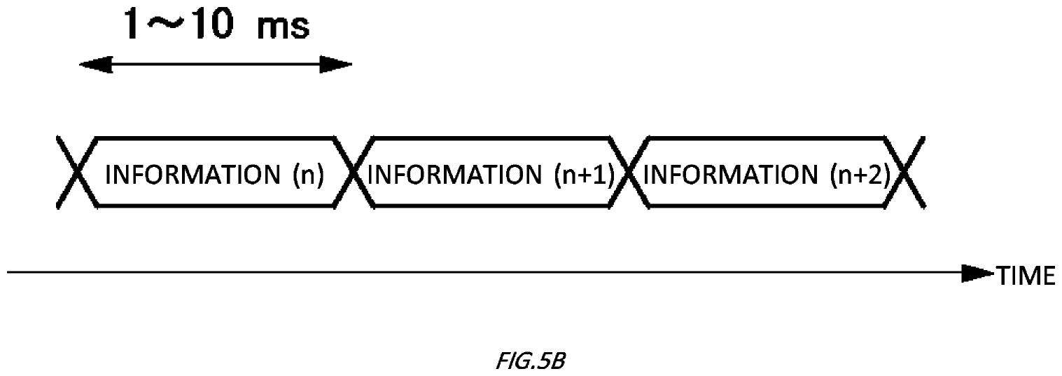

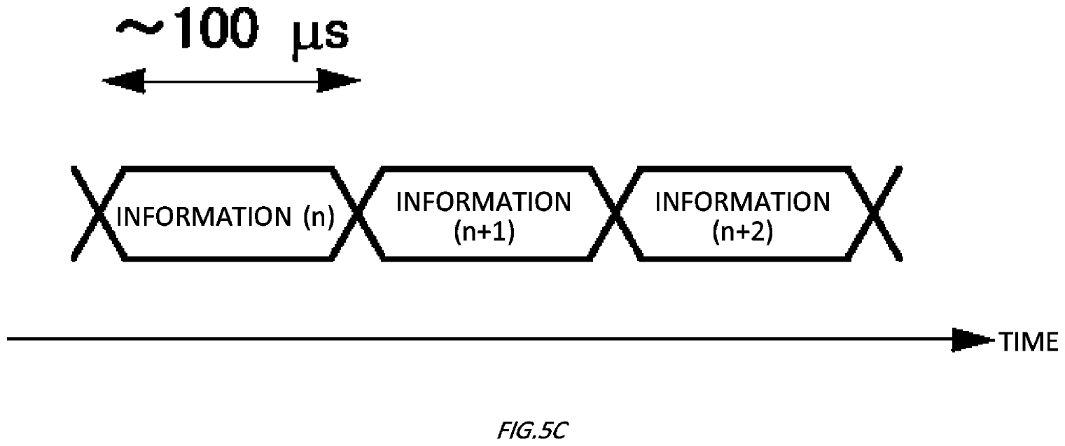

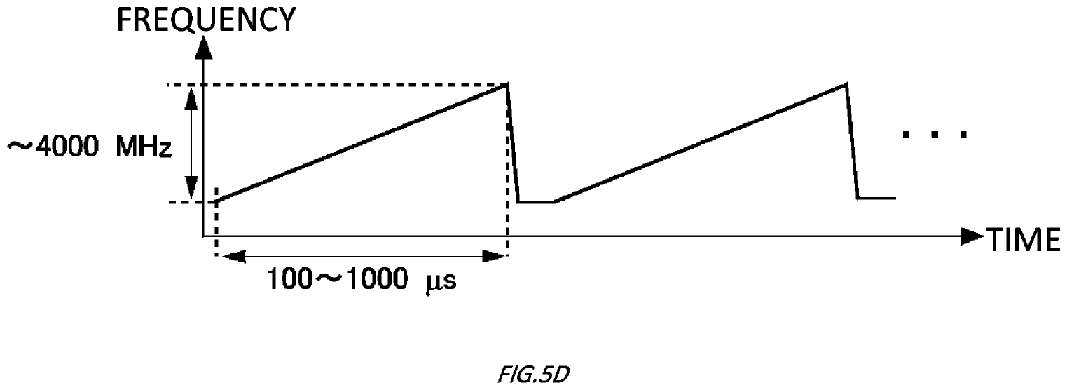

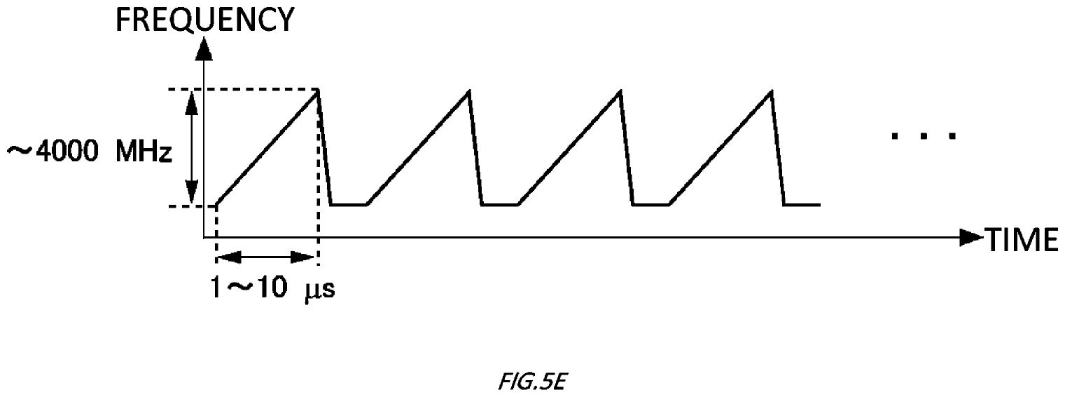

FIG. 5A is a diagram illustrating an update rate necessary for obtaining the body motion data of the object 300. As illustrated in FIG. 5A, the sensor device 100 may update information in units of several tens of milliseconds to several hundreds of milliseconds in order to obtain the body motion data of the object 300.

FIG. 5B is a diagram illustrating an update rate necessary for obtaining the micro-vibration data of the object 300. Unlike FIG. 5A, the sensor device 100 may update information in units of one millisecond to several milliseconds in order to obtain the micro-vibration data of the object 300. That is, in order to obtain the micro-vibration data of the object 300, the sensor device 100 may update information at a higher frequency than that in the case of obtaining the body motion data.

FIG. 5C is a diagram illustrating an update rate necessary for obtaining the sound data of the object 300. Unlike FIGS. 5A and 5B, the sensor device 100 may update information in units of several tens of microseconds in order to obtain the sound data of the object 300. That is, in order to obtain the sound data of the object 300, the sensor device 100 may update information more frequently than that in the case of obtaining the micro-vibration data.

FIG. 5D is a diagram illustrating the chirp setting necessary for obtaining the body motion data and the micro-vibration data of the object 300 in the object detection mode. As illustrated in FIG. 5D, in the object detection mode, the transmission/reception unit 10 may set the frequency modulation of the chirp to several mega Hz/μs to several tens of mega Hz/μs in order to obtain the body motion data and the micro-vibration data of the object 300. By updating information in units of one millisecond to several hundred milliseconds, the IF signal proportional to the TOF can be detected in a wide range when converted by the AD conversion unit 22 having a finite band, and the body motion data and the micro-vibration data can be obtained.

FIG. 5E is a diagram illustrating the chirp setting necessary for obtaining the sound data of the object 300 in the sound detection mode. As illustrated in FIG. 5E, in the sound detection mode, the transmission/reception unit 10 may set the frequency modulation of the chirp to several hundreds of mega Hz/μs to several giga Hz/μs in order to obtain the sound data of the object 300. By updating the information in several tens of microseconds, the sound data can be obtained.

As illustrated in FIGS. 5A to 5C, the sensor device 100 may switch the update rate depending on which information of the object 300 needs to be detected by the sensor device 100. In addition, as illustrated in FIGS. 5D and 5E, the transmission/reception unit 10 may switch the chirp setting between the object detection mode of obtaining the body motion data and the micro-vibration data and the sound detection mode of obtaining the sound data. In the present example, the information regarding the object 300 can be obtained by appropriately switching the first mode for obtaining the body motion data of the object 300 illustrated in FIGS. 5A and 5D, the second mode for obtaining the micro-vibration data of the object 300 illustrated in FIGS. 5B and 5D, and the third mode for obtaining the sound data of the object 300 illustrated in FIGS. 5C and 5E.

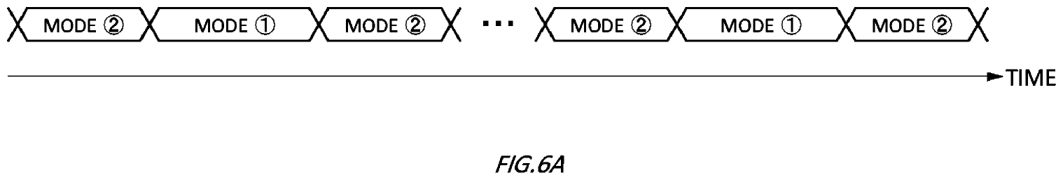

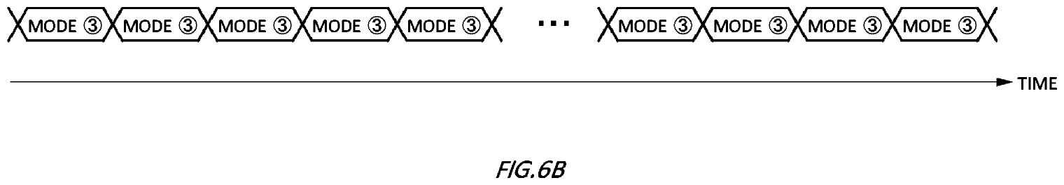

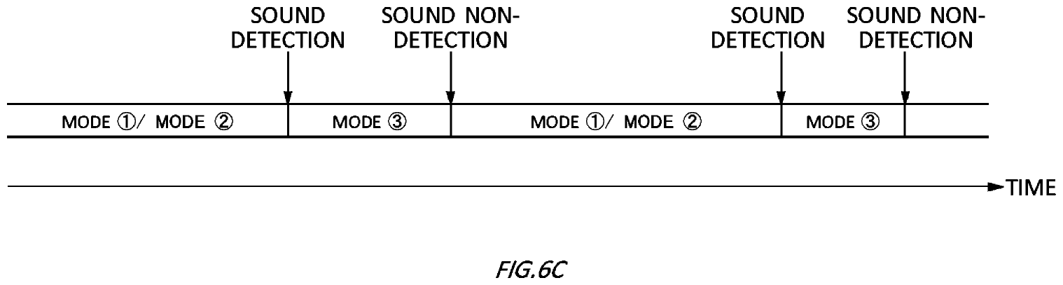

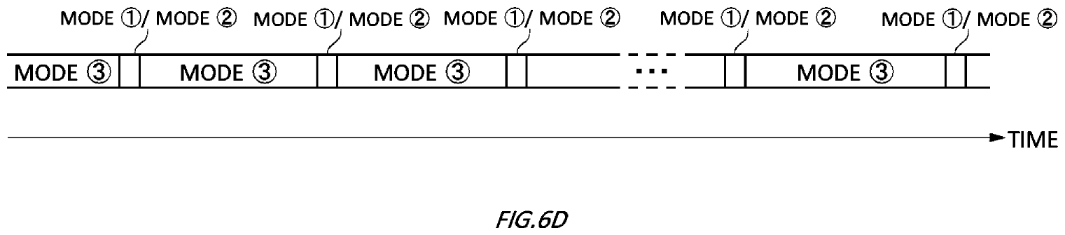

FIG. 6A is a schematic diagram illustrating an example of an operation in the object detection mode. In the object detection mode, the sensor device 100 and the transmission/reception unit 10 operate with switching between the first mode and the second mode. The sensor device 100 and the transmission/reception unit 10 can obtain the body motion data and the micro-vibration data of the object 300 by operating in the object detection mode.

FIG. 6B is a schematic diagram illustrating an example of an operation in the sound detection mode. The sensor device 100 and the transmission/reception unit 10 are operating in the third mode in the sound detection mode. The sensor device 100 and the transmission/reception unit 10 can obtain the sound data of the object 300 by operating in the sound detection mode.

FIG. 6C is a schematic diagram illustrating an example of the operation of the sensor device 100 and the transmission/reception unit 10. In the present example, during a steady state in which the sound detection unit 50 does not detect a sound, the sensor device 100 and the transmission/reception unit 10 are operating in the object detection mode in which an operation is performed with switching between the first mode and the second mode.

When the sound detection unit 50 detects a sound, the mode control unit 60 switches the operation mode of the sensor device 100 and the transmission/reception unit 10 from the object detection mode to the sound detection mode. In the present example, during a non-steady state in which the sound detection unit 50 detects a sound, the sensor device 100 and the transmission/reception unit 10 continue to operate in the third mode.

When the sound detection unit 50 does not detect a sound, the mode control unit 60 switches the operation modes of the sensor device 100 and the transmission/reception unit 10 from the sound detection mode to the object detection mode. As described above, by switching the operation mode with the sound detection as a trigger, the detection of the object 300 including the sound detection can be performed with a minimum signal processing capability while reducing the power consumption.

FIG. 6D is a schematic diagram illustrating another example of the operation of the sensor device 100 and the transmission/reception unit 10. In the present example, the operation in the sound detection mode is performed as a main operation. The sensor device 100 and the transmission/reception unit 10 perform detection in the object detection mode during a predetermined first period, and perform detection in the sound detection mode during a predetermined second period. The mode control unit 60 controls the operation such that the second period is longer than the first period, whereby radar detection can be performed with the sound detection as the main operation. Even in such an operation, for example, at the time of the operation in the object detection mode, by switching a processing function to a low-speed operation, the detection of the object 300 including the sound detection can be performed while reducing the power consumption.

It is assumed that in the operation while the sound detection unit 50 detects a sound, the data obtained by the operation in the object detection mode is not necessarily useful. For example, in a state where the object 300 is uttering a sound, biological information such as respiration and heartbeat is expected to greatly fluctuate, and there is a possibility that correct detection cannot be performed. In addition, as illustrated in FIGS. 5A and 5C, there is a possibility that the information of the object 300 obtained in the first mode does not cause a problem even when the update rate is low. Therefore, even in the operation as illustrated in FIG. 6D, the detection of the object 300 including the sound detection can be performed with a minimum signal processing capability while reducing the power consumption.

In the present example, the sound detection is enabled only by adding a simple configuration without impairing the original function of the FMCW radar 400 that detects the position of an object, micro-vibration, or the like. As a result, when a radar is used for the purpose of watching over an infant, an elderly person, a person requiring care, or the like, it is possible to provide a function, such as detecting sounds of a plurality of living bodies to be watched over simultaneously, which it has been conventionally difficult to provide.

In addition, in the embodiment or the like, a configuration for detecting a sound of a living body has been mainly described, but the present invention is not limited thereto. That is, even when the target is audio equipment or the like such as a speaker, the vibration generated by the speaker or the like can be detected, and the position and the sound thereof can be detected by a method similar to the above-described method.

As a further application example, even in a case where a living body to be observed is wearing a mask, a case where a shielding plate or the like for preventing diffusion of splashes is installed, or the like, vibration appears on the surface of the mask or the shielding plate at the time of utterance of the living body utters, and thus, it is possible to detect a sound by a method similar to the above-described method. In this case, for example, the sound detection can be more efficiently performed by using, as the material of the shielding plate or the like, a material, such as aluminum foil, which easily vibrates.

While the present invention has been described with the embodiments, the technical scope of the present invention is not limited to the scope of the above described embodiments. It is apparent to persons skilled in the art that various alterations or improvements can be added to the above-described embodiments. It is also apparent from the scope of the claims that the embodiments added with such alterations or improvements can be included in the technical scope of the invention.

It should be noted that the operations, procedures, steps, stages, etc. of each process performed by an device, system, program, and method shown in the claims, specification, or diagrams can be performed in any order as long as the order is not indicated by “prior to,” “before,” or the like and as long as the output from a previous process is not used in a later process. Even if the operational flow is described by using phrases such as “first” or “next” in the claims, specification, or diagrams, it does not necessarily mean that the process must be performed in this order.

### EXPLANATION OF REFERENCES

10: transmission/reception unit; 12: transmission unit; 14: reception unit; 20: input unit; 22: AD conversion unit; 30: signal processing unit; 31: selection unit; 32: FFT conversion unit; 33: power conversion unit; 34: determination unit; 35: storage unit; 36: data processing unit; 37: information accumulation unit; 38: phase conversion unit; 39: micro-vibration identification unit; 139: first frequency analysis unit; 239: second frequency analysis unit; 40: data output unit; 41: body motion data output unit; 42: micro-vibration data output unit; 43: sound data output unit; 50: sound detection unit; 51: position specifying unit; 52: timing specifying unit; 60: mode control unit; 100: sensor device; 200: system; 300: object; and 400: FMCW radar.

What is claimed is:

1. A sensor device configured to sense an object by using an FMCW radar, the sensor device comprising:
a signal processing unit configured to acquire a reception signal based on a reception wave of the FMCW radar and output a processing signal obtained by sensing the object;
a sound detection unit configured to detect a sound-related signal related to a sound from the object on a basis of the processing signal; and
a mode control unit configured to switch an operation mode of the sensor device between an object detection mode for detecting the object and a sound detection mode for detecting a sound from the object on a basis of a detection result of the sound detection unit.

2. The sensor device according to claim 1, wherein
the sound detection unit includes a timing specifying unit configured to specify an utterance timing of utterance from the object on a basis of the sound-related signal, and
the mode control unit is configured to switch the object detection mode to the sound detection mode on a basis of the utterance timing.

3. The sensor device according to claim 1, wherein
the signal processing unit includes a phase conversion unit for extracting phase data of coordinates of the sensed object.

4. The sensor device according to claim 3, wherein
the signal processing unit is configured to output position information related to a position of the object as the processing signal, and
the sound detection unit is configured to detect a sound-related signal from the object on a basis of the position information.

5. The sensor device according to claim 3, wherein
the signal processing unit includes a micro-vibration identification unit configured to acquire micro-vibration information related to micro-vibration of the object on a basis of the phase data,
the micro-vibration identification unit is configured to output, as the processing signal, micro-vibration information related to the micro-vibration of the object, and
the sound detection unit is configured to detect a sound-related signal from the object on a basis of the micro-vibration information.

6. The sensor device according to claim 5, wherein
the sound detection unit includes a position specifying unit configured to specify an utterance position of a sound from the object on a basis of the sound-related signal, and
the micro-vibration identification unit is configured to perform frequency analysis on the phase data corresponding to the utterance position.

7. The sensor device according to claim 5, comprising:
a sound data output unit for outputting sound data on a basis of the phase data extracted in the sound detection mode.

8. The sensor device according to claim 5, wherein
the object detection mode includes:
a first mode for detecting a position, a velocity, an angle, a shape, a posture, and a number of the object; and
a second mode for detecting micro-vibration of the object.

9. The sensor device according to claim 5, wherein
the micro-vibration identification unit includes:
a first frequency analysis unit for performing frequency analysis on the phase data to obtain micro-vibration data of the object; and
a second frequency analysis unit for performing frequency analysis on the phase data to obtain sound data.

10. The sensor device according to claim 9, wherein
the micro-vibration identification unit is configured to function as the first frequency analysis unit in the object detection mode, and function as the second frequency analysis unit in the sound detection mode.

11. The sensor device according to claim 1, wherein
the mode control unit is configured to
switch the object detection mode to the sound detection mode in response to the sound detection unit detecting a sound-related signal from the object, and
switch the sound detection mode to the object detection mode in response to the sound detection unit not detecting the sound-related signal from the object.

12. The sensor device according to claim 1, wherein
the sensor device is configured to operate in the object detection mode during a predetermined first period, and operate in the sound detection mode during a predetermined second period, and
the mode control unit is configured to control an operation mode such that the second period is longer than the first period.

13. The sensor device according to claim 1, wherein
the signal processing unit is configured to detect a plurality of objects by identifying a plurality of peaks of a power conversion spectrum of the reception signal.

14. The sensor device according to claim 1, wherein
the object is a living body, and is used for sensing the living body.

15. A system comprising:
an FMCW radar including a transmission/reception unit configured to transmit and receive an FMCW radar signal; and
the sensor device according to claim 1.

16. The system according to claim 15, wherein
the mode control unit configured to switch an operation frequency of the system according to an operation mode of the sensor device.

17. The system according to claim 16, wherein
the mode control unit is configured to
control a modulation frequency of a chirp of the transmission/reception unit to be higher than a modulation frequency in the object detection mode when the operation mode is switched to the sound detection mode.

18. A sound detection method using an FMCW radar, the sound detection method comprising:
acquiring a reception signal based on a reception wave of the FMCW radar and outputting a processing signal obtained by sensing an object;
detecting a sound-related signal related to a sound from the object on a basis of the processing signal; and
switching an operation mode of a sensor device between an object detection mode for detecting the object and a sound detection mode for detecting a sound from the object on a basis of a detection result of the sound detection unit.

19. The sound detection method according to claim 18, wherein
the outputting the processing signal obtained by sensing the object includes:
outputting position information related to a position of the object on a basis of the reception signal;
extracting phase data on a basis of the position information; and
outputting micro-vibration information related to micro-vibration of the object on a basis of the phase data, and
the detecting the sound-related signal includes
detecting a sound-related signal from the object on a basis of the position information or the micro-vibration information.

20. A radar device configured to sense an object by using an FMCW radar, the radar device comprising:
a transmission unit configured to transmit a transmission wave;
a reception unit configured to receive a reception wave reflected from the object; and
a sensor device including:
a signal processing unit configured to acquire a reception signal based on the reception wave and output a processing signal obtained by sensing the object;
a sound detection unit configured to detect a sound-related signal related to a sound from the object on a basis of the processing signal; and
a mode control unit configured to switch operation modes of the sensor device, the transmission unit, and the reception unit between an object detection mode for detecting the object and a sound detection mode for detecting a sound from the object on a basis of a detection result of the sound detection unit.
